(19) United States
(12) Patent Application Publication
(10) Pub. No.: US 2014/0084520 A1
(43) Pub. Date: Mar. 27, 2014

(54) MANUFACTURING APPARATUS OF DISPLAY DEVICE, AND MANUFACTURING METHOD OF DISPLAY DEVICE

(71) Applicant: KABUSHIKI KAISHA TOSHIBA, Tokyo (JP)

(72) Inventors: Yuto WATANABE, Zushi-shi (JP); Sei MUSHA, Kawasaki-shi (JP)

(73) Assignee: Kabushiki Kaisha Toshiba, Tokyo (JP)

(21) Appl. No.: 13/833,380

(22) Filed: Mar. 15, 2013

(30) Foreign Application Priority Data
Sep. 24, 2012 (JP) 2012-209402

(51) Int. Cl. B29C 65/00

(52) U.S. Cl. CPC B29C 65/002
USPC 264/494; 425/110

(57) ABSTRACT

According to one embodiment, a manufacturing apparatus of a display device is provided with retaining unit, a light guide plate, and light source. The retaining unit retains a first substrate, and second substrate in such a manner that the first and second substrates are opposed to each other with a photocuring agent interposed between them. The light guide plate is a light guide plate to be arranged on at least one of the opposite side of the photocuring agent with the first substrate interposed in between, and the opposite side of the photocuring agent with the second substrate interposed in between, and has a surface of a size covering the photocuring agent. The light source applies light configured to cure the photocuring agent to the light guide plate.

### CROSS-REFERENCE TO RELATED APPLICATIONS

This application is based upon and claims the benefit of priority from Japanese Patent Application No. 2012-209402, filed Sep. 24, 2012, the entire contents of which are incorporated herein by reference.

### FIELD

Embodiments described herein relate generally to, for example, a manufacturing method of a display device used to fix a liquid crystal panel and cover glass to each other. Embodiments of the present invention relate to, for example, a manufacturing method of a display device used to fix a liquid crystal panel and cover glass to each other.

### BACKGROUND

Heretofore, when a cover glass is to be fixed to a liquid crystal panel, a UV curing agent is applied to the cover glass. Next, the liquid crystal panel and cover glass are opposed to each other with respect to the relative position of the cover glass to the liquid crystal panel in such a manner that the UV curing agent is positioned between the liquid crystal panel and cover glass, and the liquid crystal panel and cover glass are bonded to each other through the UV curing agent. By applying ultraviolet light to the entire area of the UV curing agent held between the liquid crystal panel and cover glass, the UV curing agent is cured, thereby bonding the liquid crystal panel and cover glass to each other.

### BRIEF DESCRIPTION OF THE DRAWINGS

FIG. 1 is a schematic view showing a panel manufacturing apparatus according to an embodiment.

FIG. 2 is a schematic view showing a provisional curing device of the panel manufacturing apparatus.

FIG. 3 is a plan view showing a plurality of reflection members in a state where the reflection members are fixed on an inversion stage of the provisional curing device.

FIG. 4 is a perspective view showing the inversion stage, a reflection section, and light guide plate opposed to a pressurization stage by being inverted by an inversion mechanism of the provisional curing device.

FIG. 5 is a cross-sectional view of the provisional curing device showing along line F5-F5 of FIG. 4.

FIG. 6 is a cross-sectional view showing a provisional curing device of a panel manufacturing apparatus according to a second embodiment cut in the same manner as FIG. 5.

### DETAILED DESCRIPTION

In general, according to one embodiment, a manufacturing apparatus of a display device is provided with retaining unit, a light guide plate, and light source. The retaining unit retains a first substrate, and second substrate in such a manner that the first and second substrates are opposed to each other with a photocuring agent interposed between them. The light guide plate is a light guide plate to be arranged on at least one of the opposite side of the photocuring agent with the first substrate interposed in between, and the opposite side of the photocuring agent with the second substrate interposed in between, and has a surface of a size covering the photocuring agent. The light source applies light configured to cure the photocuring agent to the light guide plate.

In general, according to one embodiment, a manufacturing method of a display device includes a first process, and second process which are carried out by using the manufacturing apparatus of a display device. In the first process, the second substrate is opposed to the first substrate in such a manner that the photocuring agent is interposed between them. In the second process, light is applied to the light guide plate arranged on at least one of the opposite side of the photocuring agent with the first substrate interposed in between, and the opposite side of the photocuring agent with the second substrate interposed in between.

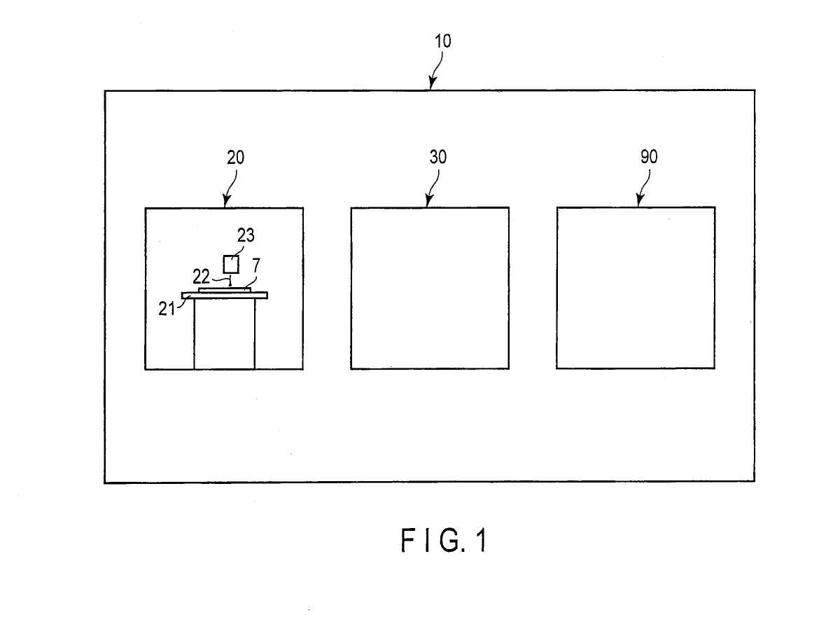

A manufacturing apparatus of a display device, and a manufacturing method of a display device according to a first embodiment will be described below by using FIGS. 1 to 5. FIG. 1 is a schematic view showing a panel manufacturing apparatus 10 which is an example of a manufacturing apparatus of a display device. In this embodiment, the panel manufacturing apparatus 10 manufactures a liquid crystal panel device 5 as an example. The liquid crystal panel device 5 is an example of a display device, and is a device in which a cover glass 7 is fixed to a liquid crystal panel 6. As shown in FIG. 1, the panel manufacturing apparatus 10 is provided with an application device 20, provisional curing device 30, and formally curing device 90.

As shown in FIG. 1, in this embodiment, the application device 20 is provided with, as an example, a stage 21 on which a cover glass 7 is fixed, and nozzle 23 configured to apply a photocuring agent 22 to the cover glass 7 arranged on the stage 21. The stage 21 is movable in a direction parallel to a surface of the cover glass 7. The relative position of the cover glass 7 to the nozzle 23 can be changed by moving the stage 21. The stage 21 is moved in such a manner that the photocuring agent supplied from the nozzle 23 is applied to the entire surface of the cover glass 7 leaving no space. The photocuring agent 22 has the property of curing by being irradiated with light of a specific wavelength. In this embodiment, the photocuring agent 22 cures when ultraviolet light is applied thereto. Ultraviolet light is an example of the above-mentioned specific light.

The provisional curing device 30 has a function of provisionally fixing the cover glass 7 to the liquid crystal panel 6. The term “provisionally fixing” mentioned here implies fixing of such a degree that the liquid crystal panel 6 and cover glass 7 can be fixed to each other so that the relative positions of the liquid crystal panel 6 and cover glass 7 can appropriately be maintained until the curing agent is permanently cured by the formally curing device 90 to be described later.

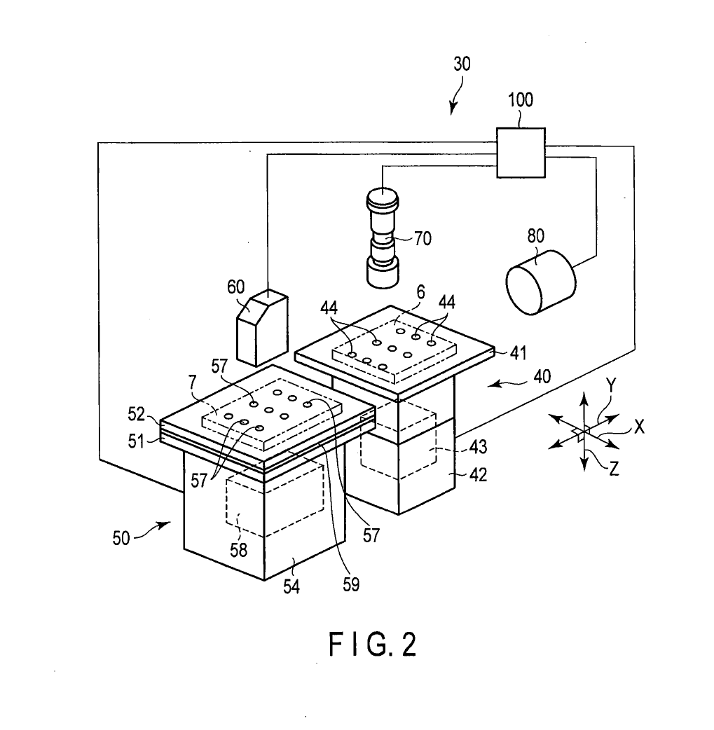

FIG. 2 shows the provisional curing device 30. As shown in FIG. 2, the provisional curing device 30 is provided with a pressurization device 40 to which the liquid crystal panel 6 is fixed, an inversion device 50 to which the cover glass 7 coated with the photocuring agent 22 by the application device 20 is fixed, a laser displacement gage 60, a position correction camera 70, an ultraviolet (UV) irradiation device 80, and a control device 100.

The pressurization device 40 is provided with a pressurization stage 41, drive device 42, and first suction device 43. On the pressurization stage 41, the liquid crystal panel 6 is placed. In the pressurization stage 41, a plurality of first suction holes 44 are formed. The liquid crystal panel 6 is arranged on the first suction holes 44. The first suction device 43 is shown by dotted lines in FIG. 2.

The first suction device 43 is provided with, for example, a pump configured to generate a negative pressure. The first suction device 43 applies a negative pressure to the first suction holes 44. By the action of the negative pressure generated by the first suction device 43 exerted on the liquid crystal panel 6 through the first suction holes 44, the liquid crystal panel 6 is fixed on the pressurization stage 41. In FIG. 2, the liquid crystal panel 6 fixed on the pressurization stage 41 is shown by two-dot chain lines.

The drive device 42 can move the pressurization stage 41 in the X- and Y-directions along the surface of the pressurization stage 41, and can also move the stage 41 in the Z-direction perpendicular to the X- and Y-directions. The Z-direction is a direction perpendicular to the surface of the pressurization stage 41.

The inversion device 50 is provided with an inversion stage 51, light guide plate 52 fixed on the inversion stage 51, reflection section 59, inversion mechanism 54, and second suction device 58. In the inversion state 51, a plurality of second suction holes 55 are formed.

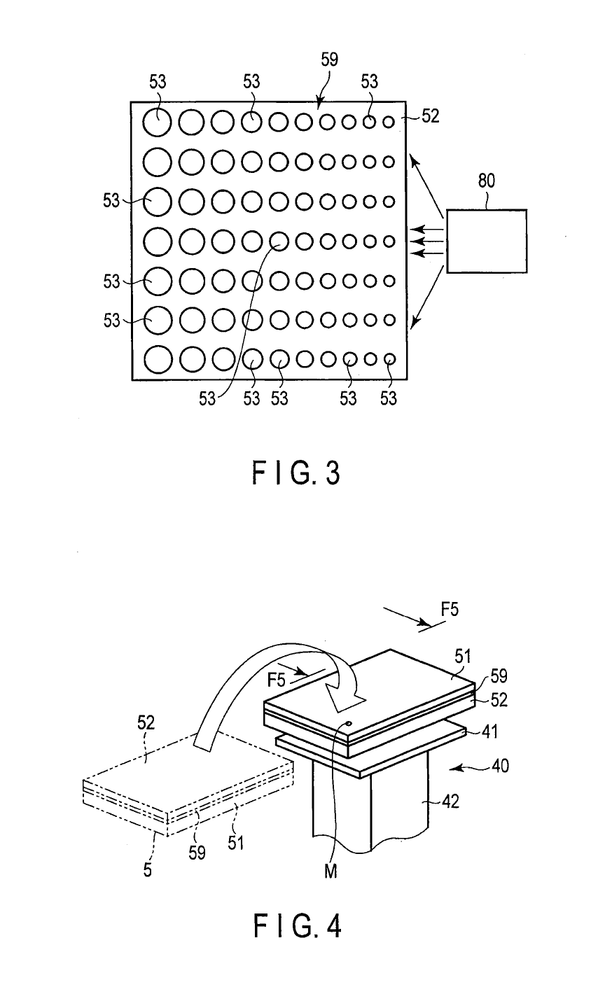

The reflection section 59 is constituted of a plurality of reflection members 53. The plurality of reflection members 53 are fixed on the inversion stage 51. FIG. 3 is a plan view showing the plurality of reflection members 53 in a state where the member 53 are fixed on the inversion stage 51. As shown in FIG. 3, as the reflection members 53, a plurality of members of different sizes are used. In this embodiment, the planar shape of each of the reflection members 53 is a circle. Arrangement of the reflection members 53 will be described later in more detail.

Here, positions of the second suction holes 55 to be formed in the inversion stage 51 will be described. As described above, the reflection members 53 are not provided throughout the entire surface of the inversion stage 51, and the plurality of reflection members 53 are arranged on the entire surface of the inversion stage 51. The second suction holes 55 to be formed in the inversion stage 51 are arranged at positions opposed to the reflection members 53. In the reflection member 53, at a part coinciding with the second suction hole 55, a third suction hole 56 coinciding with the second suction hole 55 is formed. The third suction hole 56 penetrates the reflection member 53. Each of the reflection members 53 is formed of, for example, a fluororesin or an acrylic resin.

The light guide plate 52 is fixed on the reflection members 53. The planar shape of the light guide plate 52 is a quadrangle. The light guide plate 52 has the same size as the inversion stage 51, and covers the entire surface of the inversion stage 51. The inside of the light guide plate 52 is formed of an ultraviolet-transmittable material, and is formed of, for example, an acrylic resin or quartz glass. In the light guide plate 52, at positions opposed to the third suction holes 56 formed in the reflection members 53, fourth suction holes 57 communicating with the third suction holes 56 are formed. The fourth suction holes 57 penetrate the light guide plate 52.

The second suction hole 55 formed in the inversion stage 51, the third suction hole 56 formed in the reflection member 53, and the fourth suction hole 57 formed in the light guide plate 52 communicate with each other.

The second suction device 58 is accommodated in the inversion mechanism 54 to be described later. Accordingly, in FIG. 2, the second suction device 58 is shown by dotted lines. The second suction device 58 is provided with, for example, a pump configured to generate a negative pressure. The negative pressure generated by the second suction device 58 acts on the second suction holes 55 formed in the inversion stage 51.

The cover glass 7 coated with the photocuring agent 22 by the application device 20 is placed on the light guide plate 52 in such a manner that a surface thereof coated with no photocuring agent 22 is opposed to the light guide plate 52. By the negative pressure generated by the second suction device, and acting on the second suction holes 55 in the inversion stage 51, third suction holes in the reflection members 53, and fourth suction holes 57 in the light guide plate 52, the cover glass 7 is fixed on the light guide plate 52. In FIG. 2, the cover glass 7 fixed on the light guide plate 52 is shown by two-dot chain lines.

The inversion mechanism 54 inverts the inversion stage 51 to oppose the stage 51 to the pressurization stage 41. Accordingly, the reflection members 53, light guide plate 52, and cover glass 7 which are fixed on the inversion stage 51 are also inverted simultaneously. FIG. 4 shows the inversion stage 51, reflection section 59, and light guide plate 52 which are inverted by the inversion mechanism 54, and are opposed to the pressurization stage 41. It should be noted that in FIG. 4, the inversion stage 51, reflection section 59, and light guide plate 52 before being inverted are shown by two-dot chain lines.

As shown in FIG. 2, the laser displacement gage 60 is provided to be positioned above the inversion device 50, and pressurization device 40. The laser displacement gage 60 is movable in the X- and Y-directions. The laser displacement gage 60 measures the thicknesses of the liquid crystal panel 6, and cover glass 7 by applying laser light to them, and detecting the reflected part of the applied laser light. The thickness mentioned here is the width in the Z-direction.

More specifically, upon movement to a position above the inversion stage 51 in the state before inversion, the laser displacement gage 60 applies laser light to the cover glass 7 to measure the thickness of the cover glass 7. Further, upon movement to a position above the pressurization stage 41, the laser displacement gage 60 applies laser light to the liquid crystal panel 6 to measure the thickness of the liquid crystal panel 6.

The position correction camera 70 is provided to be positioned above the pressurization device 40. The position correction camera 70 images the back surface of the inversion stage 51 inverted by the inversion mechanism 54. As shown in FIG. 4, a mark M is provided on the back surface of the inversion stage 51. An image taken by the position correction camera 70 is transmitted to the control device 100.

The UV irradiation device 80 is provided at a position lateral to the pressurization stage 41. The UV irradiation device 80 applies ultraviolet light in a direction parallel to the surface of the pressurization stage 41.

The control device 100 controls operations of the inversion mechanism 54. Further, the control device 100 controls operations of the drive device 42 of the pressurization device 40 on the basis of the measurement results of the laser displacement gage 60, and the image taken by the position correction camera 70. Further, the control device 100 controls operations of the UV irradiation device 80.

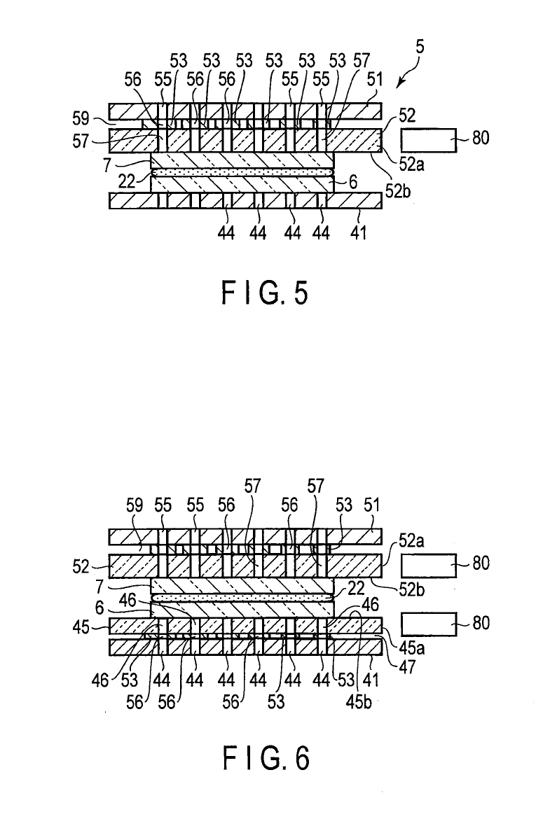

Here, the size and arrangement of the reflection members 53 will be described. FIG. 5 is a cross-sectional view of the provisional curing device shown along line F5-F5 shown in FIG. 4. FIG. 5 shows a state where the inversion stage 51 is inverted, and the cover glass 7 is opposed to the liquid crystal panel 6. This state is a state where the photocuring agent 22 is kept between the cover glass 7 and liquid crystal panel 6, and the photocuring agent 22 is in contact with the cover glass 7 and liquid crystal panel 6. As shown in FIG. 5, the UV irradiation device 80 is opposed to the side surface 52a of the inverted light guide plate 52.

FIG. 3 shows a state where the reflection section 59 is viewed from above in the state shown in FIG. 5. In FIG. 3, the inversion stage 51 is omitted. As shown in FIG. 3, the reflection members 53 are arranged on the entire area of the light guide plate 52. The planar shape of each of the reflection members 53 is a circle as an example. The farther the position of the reflection member 53 from the side surface 52a at which the ultraviolet light enters the light guide plate 52, the larger the size thereof is.

Further, the size of the reflection member will be described as follows. As shown in FIG. 5, the ultraviolet light entering the light guide plate 52 spreads inside the light guide plate 52 by being reflected from the reflection members 53. As a result, the ultraviolet light exits from the surface of the light guide plate 52 opposite to the surface on which the reflection members 53 are fixed, i.e., from the surface facing the photocuring agent 22.

If the reflection section 59 is not provided, the longer the distance from the side surface 52a on which the ultraviolet light is incident, the less the intensity of the ultraviolet light released from the surface 52b of the light guide surface tends to be. The area of each of the reflection members 53 is set in such a manner that the farther the position of the reflection member 53 from the side surface 52a, the larger the area thereof is so that the intensity of the ultraviolet light exiting from the surface 52b opposed to the photocuring agent 22 can be constant at any position of the surface 52b.

It should be noted that in this embodiment, the light guide plate 52 has the same area as the inversion stage 51, and the entire area thereof is opposed to the entire area of the inversion stage 51. In other words, the circumference of the inversion stage 51, and circumference of the light guide plate 52 coincide with each other in the direction in which the light guide plate 52 is laid on the inversion stage 51. Further, the cover glass 7 is smaller than the light guide plate 52, and hence the cover glass 7 can be held within the area of the light guide plate 52. Accordingly, in a state where the cover glass 7 is fixed on the light guide plate 52, the light guide plate 52 has a size enough to cover the entire area of the photocuring agent 22 to be applied to the cover glass 7.

In this embodiment, the formally curing device 90 is identical to the provisional curing device 30 in configuration as an example, and hence a description thereof is omitted.

Next, operations of the panel manufacturing apparatus 10 will be described. First, in the application device 20, the photocuring agent 22 is applied to the entire area of the surface of the cover glass 7. The cover glass 7 coated with the photocuring agent 22 is placed on the light guide plate 52 of the inversion device 50 of the provisional curing device 30 by conveying means.

When the cover glass 7 is placed on the light guide plate 52, the position correction camera 70 images a part on the light guide plate 52. The control device 100 drives position correction means on the basis of the image obtained by the position correction camera 70 to move the position of the cover glass 7 on the light guide plate 52 to an appropriate position. When, the cover glass 7 is moved to an appropriate position on the light guide plate 52, the control device 100 drives the second suction device 58. By driving the second suction device 58, the cover glass 7 is fixed on the light guide plate 52.

Further, the liquid crystal panel 6 is placed on the pressurization stage 41 of the pressurization device 40. The position correction camera 70 moves to a position above the pressurization stage 41 to image the pressurization stage 41. The control device 100 drives the position correction means on the basis of the image obtained by the position correction camera 70 to move the liquid crystal panel 6 to an appropriate position on the pressurization stage 41. When the liquid crystal panel 6 is moved to an appropriate position on the pressurization stage 41, the control device 100 drives the first suction device 43. By driving the first suction device 43, the liquid crystal panel 6 is fixed on the pressurization stage 41.

As described above, when the liquid crystal panel 6 is fixed on the pressurization stage 41 at an appropriate position thereof, and the cover glass 7 is fixed on the light guide plate 52 at an appropriate position thereof, the control device 100 controls the laser displacement gage 60 to measure the thicknesses of the cover glass 7, and liquid crystal panel 6.

When the thicknesses of the cover glass 7, and liquid crystal panel 6 are measured, the control device 100 controls the inversion mechanism 54 of the inversion device 50 to invert the inversion stage 51, reflection members 53, light guide plate 52, and cover glass 7, and oppose the cover glass 7 and liquid crystal panel 6 to each other.

When the cover glass 7 and liquid crystal panel 6 are opposed to each other, the position correction camera 70 images the back surface of the inversion stage 51. The control device 100 detects the position of the cover glass 7 from the obtained image.

Detection of the position of the inverted cover glass 7 will be specifically described below. As described above, the position of the cover glass 7 relative to the inversion stage 51 is already corrected, and the position of the cover glass relative to the inversion stage 51 is at an appropriate position. Further, the back surface of the inversion stage 51 is imaged by the position correction camera 70, whereby the control device 100 detects the position of the mark M provided on the back surface of the inversion stage 51.

The position of the cover glass 7 relative to the inversion stage 51 is already corrected, and is at an appropriate position, and hence it is possible to detect the position of the cover glass 7 by detecting the position of the mark M.

When the position of the cover glass 7 is detected, the control device 100 controls the drive device 42 of the pressurization device 40 in order to make the relative positions of the cover glass 7, and liquid crystal panel 6 appropriate positions.

The relative position mentioned here is the position of the cover glass 7 in the direction parallel to the surface of the liquid crystal panel 6, i.e., the position of the cover glass 7 relative to the liquid crystal panel 6 in the plane defined by the X- and Y-directions, and the position of the cover glass 7 in the direction perpendicular to the liquid crystal panel 6, i.e., the position of the cover glass 7 relative to the liquid crystal panel 6 in the Z-direction. The distance between the liquid crystal panel 6, and cover glass 7 is determined on the basis of a gap required to be present between the liquid crystal panel 6, and cover glass 7.

As described above, the position of the cover glass 7 in the X-Y plane is detected. Further, the position of the liquid crystal panel 6 relative to the pressurization stage 41 is detected. Further, the thickness of the cover glass 7, and thickness of the liquid crystal panel 6 are detected. On the basis of these information items, the control device 100 moves the pressurization stage 41 in the X-Y plane, and in the Z-direction to thereby move the position of the cover glass 7 relative to the liquid crystal panel 6 to an appropriate position. In other words, the relative positional relationship between the liquid crystal panel 6, and cover glass 7 is corrected to an appropriate relative positional relationship.

When the relative positional relationship of the cover glass 7 is corrected with respect to the liquid crystal panel 6, the control device 100 stops the operation of the drive device 42. When the operation of the drive device 42 is stopped, and the operation of the inversion mechanism 54 is also stopped, the relative position of the cover glass 7 is fixed with respect to the liquid crystal panel 6.

When the relative position of the cover glass 7 is fixed with respect to the liquid crystal panel 6, the control device 100 drives the UV irradiation device 80. By driving the UV irradiation device 80, ultraviolet light enters the light guide plate 52 from the side surface 52a. The ultraviolet light entering the light guide plate 52 exits from the surface 52b on which the cover glass 7 is fixed while spreading inside the light guide plate 52 by being reflected from the reflection members 53. At this time, the intensity of the ultraviolet light exiting from the surface 52b is identical at any position, and there is no unevenness in intensity.

The ultraviolet light exiting from the surface 52b is applied to the photocuring agent 22 after passing through the cover glass 7. By being irradiated with the ultraviolet light, the photocuring agent 22 cures in a state where the photocuring agent 22 is bonded to both the cover glass 7 and liquid crystal panel 6. By the curing of the photocuring agent 22, the liquid crystal panel 6, and cover glass 7 are fixed to each other through the photocuring agent 22 as one body while their relative positions are kept in an appropriate positional relationship.

The irradiation time of ultraviolet light taken by the UV irradiation device 80 of the provisional curing device 30 is the time by which it is possible to obtain such a degree of cure that fixation of a state where an appropriate relative positional relationship between the liquid crystal panel 6 and cover glass 7 is held by the photocuring agent 22 can be maintained until the photocuring agent 22 is subjected to formal curing in the formally curing device 90 to which the liquid crystal panel 6, and cover glass 7 are to be subsequently conveyed.

When the liquid crystal panel 6, and cover glass 7 are fixed to each other as one body by the provisional curing device 30, the one-body matter is conveyed to the formally curing device 90 by conveying means. In this embodiment, the configuration of the formally curing device 90 is, as an example, identical to the configuration of the provisional curing device 30.

The one-body matter of the liquid crystal panel 6, and cover glass 7 conveyed to the formally curing device 90 is placed on an inversion stage 51 of an inversion device 50. More specifically, the one-body matter is fixed on a light guide plate 52 fixed on the inversion stage 51 by a second suction device 58.

When the one-body matter of the liquid crystal panel 6, and cover glass 7 is fixed on the light guide plate 52, a control device 100 drives an inversion mechanism 54 to move the one-body matter of the liquid crystal panel 6, and cover glass 7 to a position on a pressurization stage 41.

It should be noted that the overall thickness (width in the Z-direction) of the one-body matter of the liquid crystal panel 6, and cover glass 7 is already calculated and grasped on the basis of the relative position of the cover glass 7 to the liquid crystal panel 6, and detection results the thicknesses of the liquid crystal panel 6, and cover glass 7 obtained by the laser displacement gage 60.

The control device 100 controls a drive device 42 of a pressurization device 40 to adjust the position of the pressurization stage 41 in the Z-direction in order to prevent the one-body matter of the liquid crystal panel 6, and cover glass 7 from colliding with the pressurization stage 41 when the one-body matter is inverted.

It should be noted that the control device 100 may measure the thickness of the one-body matter of the liquid crystal panel 6, and cover glass 7 by means of the laser displacement gage 60 when the one-body matter of the liquid crystal panel 6, and cover glass 7 is fixed on the inversion stage 51.

When the one-body matter of the liquid crystal panel 6, and cover glass 7 is inverted by an inversion mechanism 54, the control device 100 drives a UV irradiation device 80. Ultraviolet light emitted from the UV irradiation device 80 enters the light guide plate 52 from the side surface 52a thereof, and is applied to the photocuring agent 22.

The formally curing device 90 is used to more strongly cure the curing agent cured by the provisional curing device 30. The ultraviolet irradiation time of the UV irradiation device 80 in the formally curing device 90 is set so that a desired degree of cure can be obtained. The desired degree of cure mentioned here is a degree of cure required of the liquid crystal panel device 5.

In the panel manufacturing apparatus 10 configured as described above, it is possible, by using the light guide plate 52, to apply ultraviolet light to the entire surface of the photocuring agent 22 while maintaining the cover glass 7 to the liquid crystal panel 6 at an appropriate relative position. Thereby, it is possible to cure the photocuring agent 22 applied to the entire surface of the cover glass 7, i.e., all the photocuring agent 22 applied to the entire surface of the cover glass 7 leaving no space.

All the photocuring agent 22 is cured to the same degree, i.e., the photocuring agent 22 is not partially cured, whereby no partial change in the volume of the photocuring agent occurs, and hence unevenness in the thickness of the photocuring agent 22 is prevented from occurring, and the cover glass 7 is therefore prevented from warping with respect to the liquid crystal panel 6.

As described above, it is possible to fix the liquid crystal panel 6, and cover glass 7 to each other in such a manner that the cover glass 7 never warps with respect to the liquid crystal panel 6 while maintaining the cover glass 7 in an appropriate relative position with respect to the liquid crystal panel 6.

Further, the reflection section 59 is provided with a plurality of reflection member 53, and the farther the position of the reflection member 53 from the side surface 52a at which the ultraviolet light enters the light guide plate 52, the larger the area thereof is. Further, the area of each of the reflection members 53 is set in such a manner that in the light guide plate 52, the intensity of ultraviolet light is constant at any position on the surface 52b opposed to the photocuring agent 22.

Accordingly, any position of the photocuring agent 22 is irradiated with ultraviolet light of the same intensity, and hence the photocuring agent 22 is cured to the same degree at any position thereof, whereby no unevenness in cure occurs. Therefore, it is possible to prevent warping of the cover glass 7 relative to the liquid crystal panel 6 resulting from unevenness in cure from occurring.

Next, a manufacturing apparatus of a display device, and manufacturing method of a display device according to a second embodiment will be described below by using FIG. 6. It should be noted that the configuration having the similar function as the first embodiment is denoted by the same reference symbol as the first embodiment, and a description thereof is omitted. In this embodiment, the structure of a pressurization device 40 is different from the first embodiment. Further, this embodiment differs from the first embodiment in that each of a provisional curing device 30, and formally curing device 90 is provided with two UV irradiation devices 80.

FIG. 6 is a cross-sectional view showing a state where an inversion stage 51 is inverted by an inversion mechanism 54 in a provisional curing device 30 of this embodiment in the same manner as FIG. 5. As shown in FIG. 6, in this embodiment, on a pressurization stage 41, a reflection section 47 is fixed, and on the reflection section 47, a light guide plate 45 is fixed.

The reflection section 47 is identical to the reflection section 59 of the inversion device 50, is provided with a plurality of reflection members 53 different from each other in size, and the farther the position of each of the plurality of reflection members 53 from the side surface 45a at which ultraviolet light emitted from a UV irradiation device 80 to be described later enters the light guide plate 45 to be described later, the larger the area thereof is. Further, the size of each of the reflection members 53 is set in such a manner that the intensity of the ultraviolet light exiting from the surface 45b on the liquid crystal panel 6 side of the light guide plate 45 is identical at any position. A third suction hole 56 in each of the reflection members 53 communicates with each of first suction holes 44 in the pressurization stage 41.

The light guide plate 45 may be identical to the light guide plate 52 of the inversion device 50. Fifth suction holes 46 are formed in the light guide plate 45 fixed on the pressurization stage 41. Each of the fifth suction holes 46 communicates with each of third suction holes 56 formed in the reflection members 53. On the pressurization stage 41, the liquid crystal panel 6 is fixed on the light guide plate 45.

The light guide plate 45 has a quadrangular planar shape and, as shown in FIG. 6, is larger than the entire surface of a photocuring agent 22, and a one-body matter of the liquid crystal panel 6, and a cover glass 7 can be held within the area of the light guide plate 45. Accordingly, the light guide plate 45 covers the entire surface of the photocuring agent 22.

One of the UV irradiation devices 80 is arranged at a position lateral to the light guide plate 52 fixed on the inversion stage 51 in an inverted state in the same manner as the first embodiment, and the other of the UV irradiation devices 80 is arranged to be opposed to a side surface of the light guide plate 45 fixed on the pressurization stage 41.

The formally curing device 90 has the same configuration as the above-mentioned provisional curing device 30.

In this embodiment, ultraviolet light emitted from the one UV irradiation device 80 is applied to the photocuring agent 22 through the light guide plate 52 of the inversion device 50, and cover glass 7, and ultraviolet light emitted from the other UV irradiation device 80 is applied to the photocuring agent 22 through the light guide plate 45 of the pressurization device 40, and liquid crystal panel 6.

As described above, ultraviolet light is applied to both the surface on the liquid crystal panel 6 side, and surface on the cover glass 7 side in the photocuring agent 22, and hence it is possible to further prevent unevenness in the degree of cure of the photocuring agent 22 from occurring.

It should be noted that in this embodiment, the UV irradiation device 80 configured to apply ultraviolet light to the light guide plate 45 fixed on the pressurization stage 41 may not be operated when the liquid crystal panel 6 does not transmit light. For example, only when the substrate fixed on the pressurization stage 41 transmits light, the UV irradiation device 80 may be operated.

It should be noted that in the first and second embodiments, curing of the photocuring agent 22 is divided into provisional curing and permanent curing, and thus the panel manufacturing apparatus 10 is provided with the provisional curing device 30 and formally curing device 90. This is because there is sometimes a case where it is desirable in consideration of the productivity of the liquid crystal panel device 5 that curing be divided into provisional curing and permanent curing in the case or the like where the time to apply ultraviolet light to the curing agent becomes long in order to obtain the degree of cure of the photocuring agent 22 required of the liquid crystal panel device 5.

Further, for example, in the first and second embodiments, immediately after the provisional curing of the photocuring agent 22 in the provisional curing device 30, the photocuring agent 22 is subjected to permanent curing processing in the formally curing device 90. As another example, there is a case where after the cover glass is fixed to the liquid crystal panel 6 by provisional curing, the one-body matter of these members requires some other processing item. In such a case, after fixing the relative position of the cover glass to the liquid crystal panel 6 at an appropriate position by provisional curing the photocuring agent 22 in the provisional curing device 30, the one-body matter is subject to the other processing item, and thereafter permanent curing is carried out in the formally curing device 90. In such a case, ultraviolet light is applied to the entire surface of the photocuring agent 22 by using the light guide plate 52 in the provisional curing device 30, whereby the relative position of the cover glass 7 to the liquid crystal panel 6 does not change when the one-body matter is subjected to the other processing item, this being therefore desirable.

Further, as another example, a configuration in which the photocuring agent 22 is cured to the degree of cure required of the liquid crystal panel device 5 by prolongation or the like of the ultraviolet irradiation time of the UV irradiation device 80, whereby the panel manufacturing apparatus 10 is provided with no formally curing device 90 may be employed. In this case, the provisional curing device 30 itself functions as a device configured to carry out up to permanent curing, and hence the need to provide two devices (the provisional curing device and formally curing device) configured to cure the photocuring agent 22 is eliminated, whereby the configuration of the panel manufacturing apparatus can be simplified.

Further, in the first embodiment, the light guide plate has been provided in the inversion device 50. This is because the cover glass 7 is fixed on the inversion stage 51 of the inversion device 50, and the cover glass 7 has higher ultraviolet transmittance than the liquid crystal panel 6.

For example, when the cover glass 7 is fixed on the pressurization stage 41 of the pressurization device 40, and the liquid crystal panel 6 is fixed on the inversion stage 51 of the inversion device 50, the light guide plate 52 is fixed on the pressurization stage 41, and the UV irradiation device 80 is provided to apply ultraviolet light to the light guide plate 52 fixed on the pressurization stage 41. As described above, it is sufficient if the light guide plate is provided at least on one side. It should be noted that it is better if the light guide plate is provided on each side as in the second embodiment.

Further, in the first and second embodiment, one UV irradiation device 80 is provided at each of positions opposed to the side surfaces 52a and 45a so that ultraviolet light may enter the light guide plate 52 or 45 from the one side surface 52a or 45a. As another example, in one light guide plate, light sources such as UV irradiation devices may be provided to be opposed to all the side surfaces. For example, when the light guide plate is quadrangular, each of the four side surfaces may be provided with one light source such as a UV irradiation device.

In the first and second embodiments, the liquid crystal panel 6 is an example of the first substrate, and cover glass 7 is an example of the second substrate. Each of the inversion stage 51, and pressurization stage 41 is an example of the retaining unit which retains the first and second substrates in such a manner that the substrates are opposed to each other with a photocuring agent interposed between them. The drive device 42 of the pressurization device 40 is an example of the adjusting unit which adjusts the relative positions of the first and second substrates. The UV irradiation device 80 is an example of the light source configured to emit light used to cure the curing agent.

The present invention is not limited to the above-mentioned embodiments as they are and, in the implementation stage, the constituent elements can be modified and embodied within a range not deviating from the gist of the invention. Further, by appropriately combining a plurality of constituent elements disclosed in the above-mentioned embodiments with each other, various inventions can be formed. For example, some constituent elements may be deleted from all the constituent elements shown in the above-mentioned embodiments. Furthermore, configurations of different embodiments may be combined with each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A manufacturing apparatus of a display device comprising:
retaining unit which retains a first substrate, and a second substrate in such a manner that the first and second substrates are opposed to each other with a photocuring agent interposed between the substrates;
a light guide plate which is a light guide plate to be arranged on at least one of the opposite side of the photocuring agent with the first substrate interposed in between, and the opposite side of the photocuring agent with the second substrate interposed in between, and comprises a surface of a size covering the photocuring agent; and
a light source configured to apply light used to cure the photocuring agent to the light guide plate.

2. The manufacturing apparatus of a display device according to claim 1, further comprising a reflection section provided on the opposite side of the photocuring agent with the light guide plate interposed in between.

3. The manufacturing apparatus of a display device according to claim 2, wherein
the reflection section is provided with a plurality of reflection members, and
the farther the position of the reflection member from a surface of the light guide plate at which the light enters the light guide plate, the larger the size of the reflection member is.

4. The manufacturing apparatus of a display device according to claim 3, wherein
the size of each of the reflection members is set in such a manner that the intensity of the light exiting from a surface of the light guide plate opposite to the reflection members becomes constant at any position of the surface.

5. The manufacturing apparatus of a display device according to claim 1, further comprising an application device configured to apply the photocuring agent.

6. The manufacturing apparatus of a display device according to claim 2, further comprising an application device configured to apply the photocuring agent.

7. The manufacturing apparatus of a display device according to claim 3, further comprising an application device configured to apply the photocuring agent.

8. The manufacturing apparatus of a display device according to claim 4, further comprising an application device configured to apply the photocuring agent.

9. A manufacturing method of a display device comprising:
making a second substrate opposed to a first substrate with a photocuring agent interposed in between by using the manufacturing apparatus of a display device according to claim 1; and
applying light to a light guide plate to be arranged on at least one of the opposite side of the photocuring agent with the first substrate interposed in between, and the opposite side of the photocuring agent with the second substrate interposed in between by using the manufacturing apparatus of a display device according to claim 1.

10. The manufacturing method of a display device according to claim 9, wherein the manufacturing apparatus further comprises a reflection section provided on the opposite side of the photocuring agent with the light guide plate interposed in between.

11. The method of a display device according to claim 10, wherein
the reflection section is provided with a plurality of reflection members, and
the farther the position of the reflection member from a surface of the light guide plate at which the light enters the light guide plate, the larger the size of the reflection member is.

12. The method of a display device according to claim 11, wherein
the size of each of the reflection members is set in such a manner that the intensity of the light exiting from a surface of the light guide plate opposite to the reflection members becomes constant at any position of the surface.

13. The method of a display device according to claim 9, wherein the display device further comprises an application device configured to apply the photocuring agent.

14. The method of a display device according to claim 10, wherein the display device further comprises an application device configured to apply the photocuring agent.

15. The method of a display device according to claim 11, wherein the display device further comprises an application device configured to apply the photocuring agent.

16. The method of a display device according to claim 12, wherein the display device further comprises an application device configured to apply the photocuring agent.
